(19) United States
(12) Patent Application Publication
(10) Pub. No.: US 2015/0030919 A1
(43) Pub. Date: Jan. 29, 2015

(54) ACTIVATORS FOR LEAD-ACID STORAGE BATTERY AND LEAD-ACID STORAGE BATTERY

(71) Applicants: Akiya Kozawa, (US); Shunzo Mase, (US)

(72) Inventors: Akiya Kozawa, Aichi (JP); Li Yang, Shanghai (CN); Takeshi Kawabe, Kanagawa (JP); John C. Nardi, Brunswick, OH (US)

(21) Appl. No.: 14/379,514

(22) PCT Filed: Feb. 6, 2013
(86) PCT No.: PCT/JP2013/053442

§ 371 Date: Aug. 19, 2014

(30) Foreign Application Priority Data
Feb. 20, 2012 (JP) 2012-50985

(51) Int. Cl. H01M 10/08

(52) U.S. Cl. CPC H01M 10/08; H01M 2300/0011
USPC 429/204

(57) ABSTRACT

A lead-acid battery activator characterized in that alkali polyacrylate solid particles are dispersed in the sulfuric acid aqueous solution, which is intended to extend the battery life by preventing the sulfation of negative electrode, and a lead-acid battery using said activator.

### BACKGROUND OF THE INVENTION

1. Field of the Invention

This invention relates to a long-lived activator for the life extension of lead-acid batteries and a battery using the activator.

2. Description of Related Art

Conventionally, lead-acid batteries have been widely used as a power source for starting an automotive engine. Recently, a large amount of lead-acid batteries for an electric motorcycle, which is subjected to a deep charge/discharge cycle, came to be used. Usually the battery case of these lead-acid batteries for the electric motorcycle has a simple structure with a rubber plug and a small hole at the bump of the battery case instead of a proper structure with an inlet port for rehydration. Most of these discarded deteriorated batteries have a shortage of diluted sulfuric acid of electrolyte, and the 20 to 30% of their electrodes are dried up. In order to regenerate these deteriorated batteries, it is possible to inject an activator with an injection syringe or dropper through a small hole removing the rubber plug in the small hole at the bump. Conventionally, the inventors and others discovered that polyvinyl alcohol and polyacrylic acid, which have an effect to increase the hydrogen overvoltage of the electrode in diluted sulfuric acid, were effective in eliminating the sulfation of deteriorated batteries and in making fresh batteries long-lived, and applied for patents. (For instance, see patent document 1, patent document 2, and patent document 3.)

However, when the polyacrylic acid or its alkali salt is used as an additive, it was difficult to inject the aqueous solution of these compounds through the electrolyte inlet of the battery because of the high viscosity of their aqueous solution, and when they were added in the form of a powder, the inlet opening of the battery case was too narrow. Even if they were added in the form of a powder, there was a shortcoming that a long time was required to uniformly dissolve and disperse them in the electrolytic solution. Therefore, the addition of a powder had drawbacks such as it was inferior in work efficiency, and it required a long time by the time the effect appeared.

### PRIOR ART DOCUMENTS

### Patent documents

(Patent document 1) Japanese patent gazette 3431438

(Patent document 2) Unexamined Japanese patent publication bulletin 2000-149981

(Patent document 3) Unexamined Japanese patent publication bulletin 2001-313064

### SUMMARY OF THE INVENTION

The first purpose of this invention is to provide a new lead-acid battery activator with a low viscosity of the solution and a property to be easily added to lead-acid batteries. In addition, the second purpose of this invention is to provide a lead-acid battery activator, which has effects to promptly recover the activity of negative electrode immediately after its addition and to keep the activity of negative electrode for a long time, and to provide a lead-acid battery using said activator.

### Technology to Solve the Proposed Technical Points

This invention is a lead-acid battery activator characterized in that alkali polyacrylate solid particles are dispersed in the sulfuric acid aqueous solution of 1 percent by weight or more in concentration, and preferably, said alkali polyacrylate solid particles have an average particle diameter of 0.002 to 0.5 millimeters, more preferably 0.01 to 0.1 millimeters, and the content of said particles is 0.05 to 5 percent by weight, and preferably, said alkali polyacrylate solid particles have an average molecular weight of 1,000,000 to 10,000,000, more preferably, 3,000,000 to 7,000,000.

Moreover, this invention is a lead-acid battery activator characterized in that polyvinyl alcohol of 0.1 to 3 percent by weight is further dissolved in each of the above-described sulfuric acid aqueous solutions. Moreover, this invention is a lead-acid battery activator characterized in that gelatinous silica and/or fine particles of silica having an average particle diameter of 5 to 50 micrometers by 0.01 to 3 percent by weight are further contained in each of the above-described sulfuric acid aqueous solutions.

Moreover, this invention is a lead-acid battery comprising the positive electrode of lead peroxide, the negative electrode of metal lead and the electrolytic solution of diluted sulfuric acid, characterized in that alkali polyacrylate solid particles are dispersed in said electrolytic solution, and preferably, said alkali polyacrylate solid particles have an average particle diameter of 0.002 to 0.5 millimeters, more preferably 0.01 to 0.1 millimeters, and preferably, the content of said particles in said electrolytic solution is 0.05 to 5 percent by weight, and preferably, said alkali polyacrylate has an average molecular weight of 1,000,000 to 10,000,000, more preferably 3,000,000 to 7,000,000. Moreover, this invention is a lead-acid battery, characterized in that the polyvinyl alcohol of 0.01 to 0.3 percent by weight is further dissolved in each of the above-described electrolytic solutions. Moreover, this invention is a lead-acid battery, characterized in that gelatinous silica and/or fine particles of silica having an average particle diameter of 5 to 50 micrometers by 0.001 to 0.3 percent by weight are contained in each of the above-described electrolytic solutions.

The present inventors have found that when an alkali polyacrylate powder, which is a lead-acid battery activator, is dispersed in diluted sulfuric acid, the majority of the powder is dispersed in the form of solid particles in said diluted sulfuric acid, though a small part is dissolved, and that the viscosity of the solution is kept extremely low, and its handling is extremely easy compared to a completely dissolved aqueous solution, and that said powder has an effect to recover and keep the activity of negative electrodes for a long term immediately after the addition when said powder is added to the electrolyte solution of lead-acid batteries.

In addition, the present inventors have found that an immediate effect to recover the activity of negative electrodes immediately after the addition to the electrolytic solution when polyvinyl alcohol is added along with the alkali polyacrylate powder, and that an effect to keep the activity of negative electrode for a long term further when silica is added along with the alkali polyacrylate powder to the electrolytic solution compared to the case when only an alkali polyacrylate powder is added. Sodium polyacrylate and potassium polyacrylate can be used as alkali polyacrylate that is used in this invention, and preferably, the one having an average particle diameter of 0.002 to 0.5 millimeters, more preferably, 0.01 to 0.1 millimeters is suitably used. When the average particle diameter is less than 0.002 millimeters, fine particles have a tendency to form secondary particles, and their uniform dispersing becomes difficult. When the average particle diameter is larger than 0.5 millimeters, the solid particles have a tendency to precipitate, and the addition of dispersed solution to the electrolytic solution becomes difficult. Alkali polyacrylate having an average molecular weight of 1,000,000 to 10,000,000, preferably 3,000,000 to 7,000,000 is suitably used. When the average molecular weight is less than 1,000,000, the effect to eliminate the sulfation is insufficient, and when it is larger than 10,000,000, the solubility in the electrolytic solution is too small, and the effect to eliminate the sulfation is insufficient.

The reason why the effect to eliminate sulfation is kept for a long term is attributable to that: with a decrease in concentration of the alkali polyacrylate originally dissolved in the electrolytic solution due to the oxidation at positive electrode, the solid particles of alkali polyacrylate dispersed in the electrolytic solution of lead-acid batteries are gradually dissolved in the electrolytic solution and it compensates the decrease in concentration of alkali polyacrylate.

Sulfuric acid with a concentration of 1 percent by weight or more is suitably used. When the sulfuric acid with a concentration of less than 1 percent by weight is used, the solubility of sodium polyacrylate is too high, and the viscosity of the solution increases, and its handling becomes difficult. As for the concentration of the polyvinyl alcohol used in this invention, the activator with a concentration 0.1 to 3 percent by weight and the electrolytic solution with a concentration of 0.01 to 0.3 percent by weight are suitably used. When the concentration of polyvinyl alcohol is less than these values, the sulfation elimination effect becomes insufficient. Though polyvinyl alcohol is adsorbed to the active site of negative electrode and has the biggest effect to increase the hydrogen overvoltage at charging and a big sulfation elimination effect immediately after the addition, it is easily oxidised at the surface of positive electrode during charging and disappears in comparatively short-term. Therefore, the simultaneous use of polyvinyl alcohol and alkali polyacrylate, which is comparatively hardly oxidised, enables to provide an activator effective in both short term and short term. As for the concentration of the silica used in this invention, the activator with a concentration of 0.01 to 3 percent by weight, and the electrolytic solution with a concentration of 0.001 to 0.3 is suitably used. When the concentration of silica is less than these values, the sulfation elimination effect for long-term becomes insufficient. The effect of silica in this invention is that: silica is adsorbed to the active site of negative electrode as well as alkali polyacrylate and increases the hydrogen overvoltage during charging to eliminate the sulfation. In that case, alkali polyacrylate is oxidized at the positive electrode and gradually disappears, on the other hand, silica is not oxidized at the positive electrode. Therefore, it is considered that the sulfation elimination effect continues for a long term.

### ADVANTAGEOUS EFFECT OF THE INVENTION

As described above, the activator of this invention has properties of low viscosity and to be able to easily add to lead-acid batteries. In addition, the activator of this invention and the lead-acid battery using said activator are effective for quick recovering of the activity of negative electrodes immediately after the addition and for keeping the activity of negative electrodes for a long term.

### BRIEF DESCRIPTION OF THE DRAWINGS

FIG. 1 is a graph of test results of charge/discharge cycles on lead-acid batteries using activators of this invention.

### DESCRIPTION OF THE PREFERRED EMBODIMENT(S)

Hereafter, embodiment using the activator of this invention is explained based on the examples.

### Example 1

Sodium polyacrylate powder with an average molecular weight of 5,000,000 and an average particle diameter of 0.05 millimeters was taken by 4 grams, and it was added to 200 ml of sulfuric acid of 10 normal and stirred, then it was diluted by water to make it 2000 ml in total and stirred intensely to make a lead-acid battery activator in which sodium polyacrylate solid particles were dispersed.

### Example 2

The lead-acid battery activator prepared in example 1 was sucked up using a syringe, ten milliliters of the activator were injected into each cell of the lead-acid battery (rated voltage: 12 volts, rated capacity: 12 Ah, amount of electrolyte: 100 ml/cell) for electric motorcycles through each water refilling inlet, and the charge/discharge cycling test was carried out. The discharging at a discharge current of 35 amperes was done until the terminal voltage became 10 volts, and the charging was done at a charge current of 2.3 amperes until the terminal voltage became 15 volts and then at a charge current of 0.4 amperes until the terminal voltage became 16 volts.

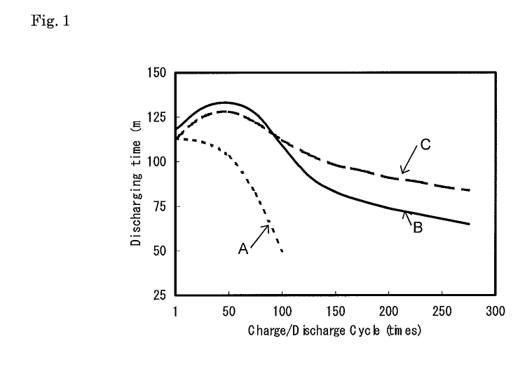

Curve B in FIG. 1 shows the results of measurement of the time when the terminal voltage became 10 volts during the discharge. As a result, the lead-acid battery B, which had the activator of this invention, was able to keep a characteristic close to a fresh battery after long charge/discharge cycles compared to the lead-acid battery A, which did not have the activator.

### Example 3

A lead-acid battery activator was prepared by adding 50% sodium silicate aqueous solution to the lead-acid battery activator, which was prepared by example 1, to make a silicic acid gel. Using this activator, the charge/discharge cycle test was done in the same condition as example 2. The result is shown in curve C in FIG. 1. As a result, the lead-acid battery C, which had the activator containing the silica of this invention and sodium polyacrylate, was able to keep a characteristic close to fresh battery after longer charge/discharge cycles compared to the lead-acid battery B, which contained only sodium polyacrylate.

### DESCRIPTION OF CODES

A: Results of charge/discharge cycle test of lead-acid battery without the activator.

B: Results of charge/discharge cycle test of lead-acid battery containing sodium polyacrylate solid particles.

C: Results of charge/discharge cycle test of lead-acid battery containing sodium polyacrylate solid particles and silica gel.

Thus, having described the invention, what is claimed is:

1. A lead-acid battery activator characterized in that alkali polyacrylate solid particles are dispersed in a sulfuric acid aqueous solution of 1 percent by weight or more in concentration.

2. The lead-acid battery activator of claim 1, wherein said alkali polyacrylate particles have an average particle diameter of 0.002 to 0.5 millimeters and the content of said particles is 0.05 to 5 percent by weight.

3. The lead-acid battery activator of claim 2, wherein said alkali polyacrylate has an average molecular weight of 1,000,000 to 10,000,000.

4. The lead-acid battery activator of claim 1 wherein polyvinyl alcohol of 0.1 to 3 percent by weight is dissolved in said sulfuric acid aqueous solution.

5. The lead-acid battery activator of claim 4, wherein said alkali polyacrylate solid particles have an average particle diameter of 0.002 to 0.5 millimeters and the content of said particles is 0.05 to 5 percent by weight.

6. The lead-acid battery activator of claim 1 wherein gelatinous silica and/or fine particles of silica having an average particle diameter of 5 to 50 micrometers by 0.01 to 3 percent by weight are contained in said sulfuric acid aqueous solution.

7. (canceled)

8. A lead-acid battery activator characterized in that alkali polyacrylate solid particles are dispersed in the sulfuric acid aqueous solution of 1 percent by weight or more in concentration, and that The lead-acid battery activator of claim 1 wherein polyvinyl alcohol of 0.1 to 3 percent by weight is dissolved in said sulfuric acid aqueous solution, moreover, gelatinous silica and/or fine particles of silica having an average particle diameter of 5 to 50 micrometers by 0.01 to 3 percent by weight are contained in said sulfuric acid aqueous solution.

9. (canceled)

10. A lead-acid battery comprising a positive electrode of lead peroxide, a negative electrode of metal lead and an electrolytic solution of diluted sulfuric acid, characterized in that alkali polyacrylate solid particles are dispersed in said electrolytic solution.

11. The lead-acid battery of claim 10, wherein said alkali polyacrylate solid particles have an average particle diameter of 0.002 to 0.5 millimeters and the content of said particles in said electrolyte is 0.05 to 5 percent by weight.

12. The lead-acid battery of claim 11, wherein said alkali polyacrylate solid particles have an average molecular weight of 1,000,000 to 10,000,000.

13. The lead-acid battery of claim 10 wherein polyvinyl alcohol of 0.1 to 3 percent by weight is further dissolved in said electrolytic solution.

14. (canceled)

15. The lead-acid battery of claim 10 wherein gelatinous silica and/or fine particles of silica having an average particle diameter of 5 to 50 micrometers by 0.001 to 0.3 percent by weight are contained in said electrolytic solution.

16. (canceled)

17. The lead-acid battery of claim 13 wherein gelatinous silica and/or fine particles of silica having an average particle diameter of 5 to 50 micrometers by 0.001 to 0.3 percent by weight are contained in said electrolytic solution.

18. (canceled)
